(19) United States
(12) Patent Application Publication
(10) Pub. No.: US 2007/0291145 A1
(43) Pub. Date: Dec. 20, 2007

(54) Methods, devices, and systems for selectable repair of imaging devices

(76) Inventors: C. Patrick Doherty, Boise, ID (US); Vinesh Sukumar, Boise, ID (US); Shaheen Amanullah, Boise, ID (US); Sachin Datar, Boise, ID (US); Nathan Walter, Boise, ID (US)

Correspondence Address: TRASK BRITT, P.C./ MICRON TECHNOLOGY, P.O. BOX 2550, SALT LAKE CITY, UT, 84110, US

(21) Appl. No.: 11/486,562

(22) Filed: Jul. 14, 2006

Related U.S. Application Data
(60) Provisional application No. 60/814,628, filed on Jun. 15, 2006.

(51) Int. Cl. H04N 5/335

(52) U.S. Cl. 348/294

(57) ABSTRACT

An image sensor includes an array of pixels on a semiconductor device for sensing light incident on the pixel array and a plurality of anomaly registers comprising a plurality of nonvolatile elements. Each anomaly register identifies an anomalous pixel cluster and includes a location indicator with a row and column address and a size indicator with a horizontal and vertical range. In other embodiments, each anomaly register includes a first address, second address, first direction flag, and second direction flag. The first and second direction flags use a first state to indicate a row address or a second state to indicate a column address. The first and second direction flags combine to define an anomalous pixel cluster, a pair of anomalous pixel rows, or a pair of anomalous pixel columns. Some embodiments may include an anomaly type indicator and some embodiments may include a shape indicator.

### CROSS-REFERENCE TO RELATED APPLICATIONS

The present application claims the benefit of U.S. Provisional Application Ser. No. 60/814,628 entitled METHODS, DEVICES, AND SYSTEMS FOR SELECTABLE REPAIR OF IMAGING filed on Jun. 15, 2006, the disclosure of which is incorporated by reference herein in its entirety.

### BACKGROUND OF THE INVENTION

1. Field of the Invention

The present invention relates generally to image sensors and, more specifically, to image sensors having anomalous pixels thereon.

2. State of the Art

Any manufactured device may include defects. In semiconductor processing, devices are generally subjected to rigorous testing to identify possible defects. A single defect may be sufficient to render a device unusable for its intended purpose. As a result, many devices, such as memories, may include redundant elements which can be used in place of an element with a defect in an effort to make a device with some defects useable.

Still other devices, such as image sensors, may be usable even with a certain number of defects present. Image sensors include an array of photo-sensitive devices such as photodiodes or photo-transistors fabricated on, for example, a complementary metal oxide semiconductor (CMOS) device. Each photo-sensitive device is sensitive to light in such a way that it can create an electrical current that is proportional to the intensity of light striking the photo-sensitive device. The overall image captured by an image sensor includes many pixels arranged in an array such that each pixel detects the light intensity at the location of that pixel. A single pixel may include a single photo-sensitive device configured for detecting a broad frequency range, which may be used for gray scale images. In addition, a pixel may be defined as a single photo-sensitive device configured for detecting a specific color (i.e., frequency). Finally, a pixel may be defined as a group of photo-sensitive devices arranged near each other wherein different devices within the group are configured for detecting different colors. Thus, a full color image may be detected with the proper combination of color sensing pixels.

Increasing the pixel density on an image sensor results in a higher resolution image. However, more pixels means more opportunities for a defect at any given pixel location. Furthermore, as pixel density increases, in general the size of each individual pixel may decrease. For defects of a given size, smaller pixels may be more vulnerable to defects than larger pixels and defects may impact a group of pixels rather than a single pixel.

As stated, image sensors may be usable even with some defects. For example, in an image sensor with perhaps millions of pixels, a handful of defective pixels, or more, may be acceptable. Furthermore, image sensors may be binned into different grades of quality depending on the number of defects, or the relative location the defective pixels in the image.

Defective pixels may manifest themselves in a variety of ways. For example, a defective pixel may appear as fully illuminated, or not illuminated at all. In order to reduce the noticeable visible effects of defective pixels, it is useful to identify the location of the defective pixel. With a defective pixel identified, post processing compensation can be performed to reduce the noticeability of the bad pixels. After an image sensor is fabricated, defective pixels may be identified during manufacturing testing and prior to placement of the image sensor in an imaging system, or may be detected with the image sensor in place in the imaging system.

Manufacturing testing may be a more controlled environment capable of better analysis of defective and anomalous pixels. Furthermore, if tested during manufacturing, the location of defective pixels may be programmed in to the imaging device at the time of the manufacturing test. Conventionally, various methods for defining the location of defective pixels have been proposed. Furthermore, nonvolatile programming elements have been proposed for storing the locations of the defective pixels. However, nonvolatile programming elements can use significant real estate on a semiconductor device and proposals using nonvolatile programming elements generally identify individual bad pixels.

### BRIEF DESCRIPTION OF THE DRAWINGS

In the drawings, which illustrate what is currently considered to be the best mode for carrying out the invention:

FIG. 1 is a simplified block diagram of an imaging system including an image sensor with on-chip anomaly registers and an external image processor in accordance with a representative embodiment of the invention;

FIG. 2 is a simplified block diagram of an image sensor with on-chip anomaly registers and an optional on-chip image processor in accordance with a representative embodiment of the invention;

FIG. 3 illustrates a portion of a pixel array including an anomalous pixel row and an anomalous pixel column;

FIG. 4 illustrates a portion of a pixel array including a variety of representative anomalous pixel clusters;

FIG. 5 illustrates a representative organization for an anomaly register;

FIG. 6 illustrates a representative organization for a location indicator portion of the anomaly register of FIG. 5;

FIG. 7 illustrates a representative organization for a size indicator portion of the anomaly register of FIG. 5;

FIG. 8 illustrates a portion of a pixel array including additional representative anomalous pixel clusters and some representative shapes of those pixel clusters;

FIG. 9 illustrates a representative organization for a shape indicator portion of the anomaly register of FIG. 5;

FIG. 10 illustrates a representative organization for an anomaly type portion of the anomaly register of FIG. 5; and

FIG. 11 illustrates another representative organization for a location indicator portion of the anomaly register of FIG. 5.

### DETAILED DESCRIPTION OF THE INVENTION

There is a need for a defective pixel identifier that includes new ways to identify multiple pixel locations and reduces the number of nonvolatile programming elements required to identify all the bad pixels on an image sensor of acceptable quality. In addition, there is a need for a defective pixel identifier that includes more information than just the location for defective pixels and defective pixel clusters.

The present invention provides methods and apparatuses for identifying anomalous pixels in an image sensor. Anomaly registers may identify multiple pixel locations in the form of anomalous pixel rows, anomalous pixel columns, and anomalous pixel clusters. Furthermore, the anomaly registers may be configured to identify cluster sizes, cluster shapes, and types of anomalies.

Representative embodiments of the invention include an image sensor device including an array of pixels arranged on a semiconductor device wherein each pixel is configured for sensing light incident on the pixel and a plurality of anomaly registers comprising a plurality of nonvolatile elements. Each anomaly register is configured to identify an anomalous pixel cluster and includes a location indicator and a size indicator. The location indicator defines a row address and a column address of the anomalous pixel cluster and the size indicator defines a horizontal range and a vertical range of the anomalous pixel cluster. Some embodiments may include an anomaly type indicator in the anomaly register to indicate a type of anomaly for the anomalous pixel cluster and some embodiments may include a shape indicator in the anomaly register to define a shape of the anomalous pixel cluster.

Another representative embodiment of the invention includes an image sensor device including an array of pixels arranged on a semiconductor device wherein each pixel is configured for sensing light incident on the pixel and a plurality of anomaly registers comprising a plurality of nonvolatile elements. Each anomaly register in this embodiment includes a first address, a second address, a first direction flag associated with the first address, and a second direction flag associated with the second address. Each of the first direction flag and the second direction flag are configured to be in a first state to indicate a row address or a second state to indicate a column address. When the first direction flag and the second direction flag are in opposite states, a combination of the first address and the second address indicates a location of an anomalous pixel cluster determined by the row address and the column address. When the first direction flag and the second direction flag are both in the first state, the first address indicates a location of a first anomalous pixel row and the second address indicates a location of a second anomalous pixel row. Finally, when the first direction flag and the second direction flag are both in the second state, the first address indicates a location of a first anomalous pixel column and the second address indicates a location of a second anomalous pixel column.

Other representative embodiments of the invention comprise methods of manufacturing an image sensor. The methods include obtaining anomaly information on each pixel of an array of pixels during fabrication and testing of a semiconductor device bearing the array of pixels. The methods further include storing at least a portion of the anomaly information in an anomaly register comprising a plurality of nonvolatile elements on the semiconductor device, wherein the portion of the anomaly information identifies an anomalous pixel cluster by indicating a location, a horizontal range, and a vertical range. Some embodiments may include storing an anomaly type of the anomalous pixel cluster and some embodiments may include storing a shape of the anomalous pixel cluster.

Another representative embodiment of the invention comprises a method of operating an image sensor. The method includes obtaining a digital representation of an image captured with the image sensor and reading at least one anomaly register of a plurality of anomaly registers on the image sensor to retrieve anomaly information for an anomalous pixel cluster. The method further includes redefining pixel values in the anomalous pixel cluster with pixel data associated with at least one pixel substantially near the anomalous pixel cluster. In this method, each anomaly register includes a location, a horizontal range, a vertical range, and an anomaly type of the anomalous pixel cluster.

Another representative embodiment of the invention comprises an imaging system includes one of the previously defined image sensors, an image processor, a memory, and a communication element. The image processor reads a digital representation of the image from the image sensor, the memory stores the digital representation, and the communication element communicates the digital representation to an external device.

In this description, circuits and functions may be shown in block diagram form in order not to obscure the present invention in unnecessary detail. Conversely, specific circuit implementations shown and described are exemplary only and should not be construed as the only way to implement the present invention unless specified otherwise herein. Additionally, block definitions and partitioning of logic between various blocks is exemplary of a specific implementation. It will be readily apparent to one of ordinary skill in the art that the present invention may be practiced by numerous other partitioning solutions. For the most part, details concerning timing considerations and the like have been omitted where such details are not necessary to obtain a complete understanding of the present invention and are within the abilities of persons of ordinary skill in the relevant art.

In this description, some drawings may illustrate signals as a single signal for clarity of presentation and description. It will be understood by a person of ordinary skill in the art that the signal may represent a bus of signals, wherein the bus may have a variety of bit widths and the present invention may be implemented on any number of data signals including a single data signal.

The terms “assert” and “negate” are respectively used when referring to the rendering of a signal, status bit, or similar apparatus into its logically true or logically false state. If the logically true state is a logic level one, the logically false state will be a logic level zero. Conversely, if the logically true state is a logic level zero, the logically false state will be a logic level one.

Representative embodiments of the present invention use nonvolatile programming elements (may also be referred to as nonvolatile elements) to store information about pixels that may include anomalies. As used herein, a nonvolatile programming element is a device capable of being programmed to at least two different states and retaining that programmed state when no power is applied to the nonvolatile element. Different types of nonvolatile programming elements may be used to implement portions of the present invention. By way of example, and not limitation, fuses, anti-fuses, laser fuses, Flash memory cells, and EPROM cells may be used as nonvolatile elements. A number of nonvolatile programming elements may be arranged in a register fashion comprising a number of bits, such that each bit within the register is available when the register is addressed.

Additionally, the nonvolatile programming elements may be defined as a “0” or a “1” when in the un-programmed state. Furthermore, some nonvolatile elements may be multi-state elements capable of storing more than two different states. For ease of description, unless specified otherwise, the nonvolatile programming elements as described herein are assumed to produce a logic “1” as an asserted level when programmed and a logic “0” as a negated level when left un-programmed.

Some representative embodiments of the present invention may identify a pixel, or pixel cluster, as “good” or “bad,” whereas other representative embodiments of the present invention may include information for defining various anomalous states of pixels or pixel clusters. For example, a pixel may be partially functional or it may be useful to know how a pixel is defective. With information about an anomaly, more intelligent compensation mechanism may be used to modify a digital representation of the anomalous pixel or pixel cluster. For example, if a pixel is partially functional, compensating the pixel may include using the value for that pixel but also augmenting it with values from one or more neighbors.

By way of example, and not limitation, some anomalies that may be of interest are pixels that appear white, bright, dark, or black. The terms white and black, as used with reference to anomalies, generally refer to full intensity, and no intensity respectively, rather than reference to a given color. Therefore, a pixel configured for a specific color, for example green, may include an anomaly of white to refer to full intensity and black to refer to no intensity. Generally, white refers to a pixel that, regardless of the intensity of light that it is exposed to, is read at substantially near a maximum value. Similarly, black refers to a pixel that, regardless of the intensity of light that it is exposed to, is read at substantially near a minimum value.

Some pixels may be partially functional. For example, a pixel may include a relatively low gain with respect to light intensity when compared to normal pixels. Thus, the pixel may respond to light but may not be able to achieve a maximum output even when exposed to high intensity light. These pixels may be referred to as dark pixels. In other words, the slope of a gain line defining change in the signal from the pixel relative to change in the light intensity may be too low. Similarly, a pixel may include a relatively high gain with respect to light intensity when compared to normal pixels. Thus, the pixel may respond to light such that it achieves a maximum output even when exposed to relatively low intensity light. These pixels may be referred to as bright pixels. In other words, the slope of a gain line defining change in the signal from the pixel relative to change in the light intensity may be too high.

Other pixel anomalies are contemplated within the scope of the present invention. By way of example, and not limitation, pixels may have an acceptable gain, but may always exhibit an offset such that for any given light intensity a pixel may appear brighter or dimmer than it should.

“Anomaly” as referred to herein, may refer to a pixel as simply bad, or may refer to various degrees and types of anomalies.

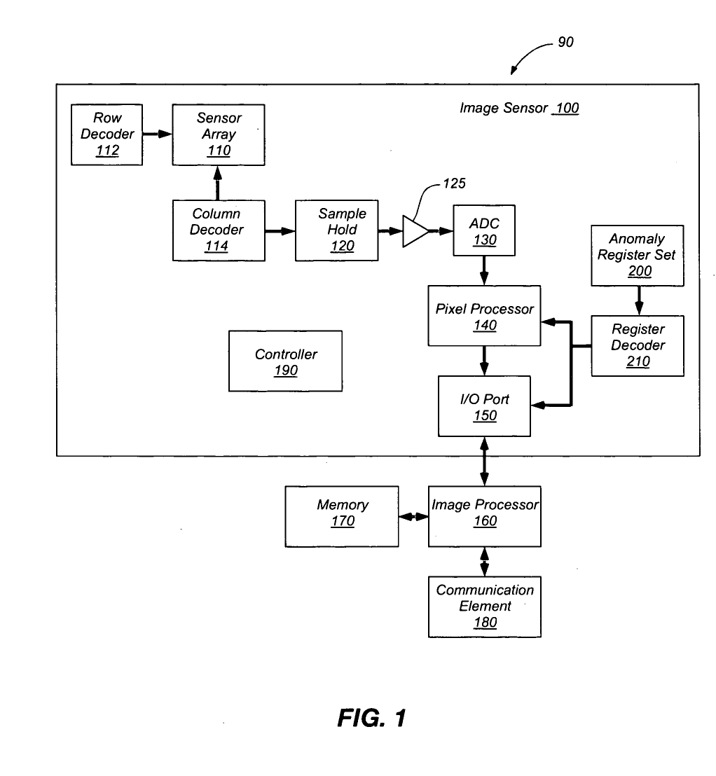

FIG. 1 is a simplified block diagram of an imaging system 90. The imaging system 90 includes an image sensor 100, and may include an image processor 160, a memory 170, and a communication element 180. The imaging system 90 may be a variety of electronic appliances or a portion of a larger system. By way of example, and not limitation, some representative imaging systems 90 may be cellular phones, digital still cameras, digital video cameras, personal digital assistants, personal computers, and surveillance devices.

The image processor may be, for example, application specific logic, a micro-controller 190, a microprocessor, a digital signal processor, or combinations thereof. The image processor 160 may perform a variety of control and signal processing functions. By way of example, and not limitation, some of these functions may be: sending and receiving control information between the image processor 160 and image sensor 100, receiving digital representations of images from the image sensor 100, storing digital representations in the memory 170, performing signal processing operations on the digital representations, and controlling other operations within the imaging system 90. It should be understood that the memory 170 might comprise a wide variety of devices including, for example, Static RAM (SRAM), dynamic RAM (DRAM), and Flash memory devices.

The communication element 180 may be used to transfer the digital representations, or other information, between the imaging system 90 and external devices (not shown). Any suitable communication element and communication protocol may be used, such as, for example, IEEE 1394, universal serial bus (USB), and wireless communications such as cellular phones, and 802.11 protocols.

The image sensor 100 includes a sensor array 110, a row decoder 112, a column decoder 114, and a controller 190. The sensor array 110 (may also be referred to as an array of pixels) includes photo-sensitive devices such as photodiodes or photo-transistors fabricated on, for example, a complementary metal oxide semiconductor (CMOS) device. Each photo-sensitive device is sensitive to light in such a way that it can create an electrical current that is proportional to the intensity of light striking the photo-sensitive device. The overall image captured by a sensor array 110 includes many pixels arranged in an array such that each pixel detects the light intensity at the location of that pixel.

As stated earlier, a single pixel may include a single photo-sensitive device configured for detecting a broad frequency range, which may be used for gray scale images. In addition, a pixel may be defined as a single photo-sensitive device configured for detecting a specific color (i.e. frequency). Finally a pixel may be a group of photo-sensitive devices arranged near each other wherein different devices within the group are configured for detecting different colors. Thus, a full color image may be detected with an appropriate combination of color sensing pixels. The term pixel as used herein may refer to a single photo-sensitive device for detecting a broad range of frequencies, a single photo-sensitive device for detecting a narrow frequency band, or a combination of photo-sensitive devices configured to capture a color image at the location of the pixel. The pixels of the sensor array 110 are arranged in individually addressable rows and columns such that the row decoder 112 can address each row of the sensor array 110 and the column decoder 114 can address each column of the sensor array 110.

While not illustrated with connections, it will be understood by those of ordinary skill in the art that the controller 190 may control functions of many or all of the other blocks within the image sensor 100. For example, the controller 190 may control the exposure of the sensor array 110 (i.e., capturing an image) and the sequencing of the row decoder 112 and column decoder 114 to read out the analog values at each pixel location within the sensor array 110.

As the pixels are each individually addressed, the resulting analog signal from each pixel may be sequentially directed from the column decoder 114 to a sample and hold unit 120 to sample the value of the analog signal and hold that value at a steady state during conversion to a digital signal. The output of the sample and hold unit 120 may be amplified by amplifier 125 for input to an analog to digital converter 130. The analog to digital converter 130 converts the analog signal for each pixel to a digital signal representing the intensity of light at that pixel.

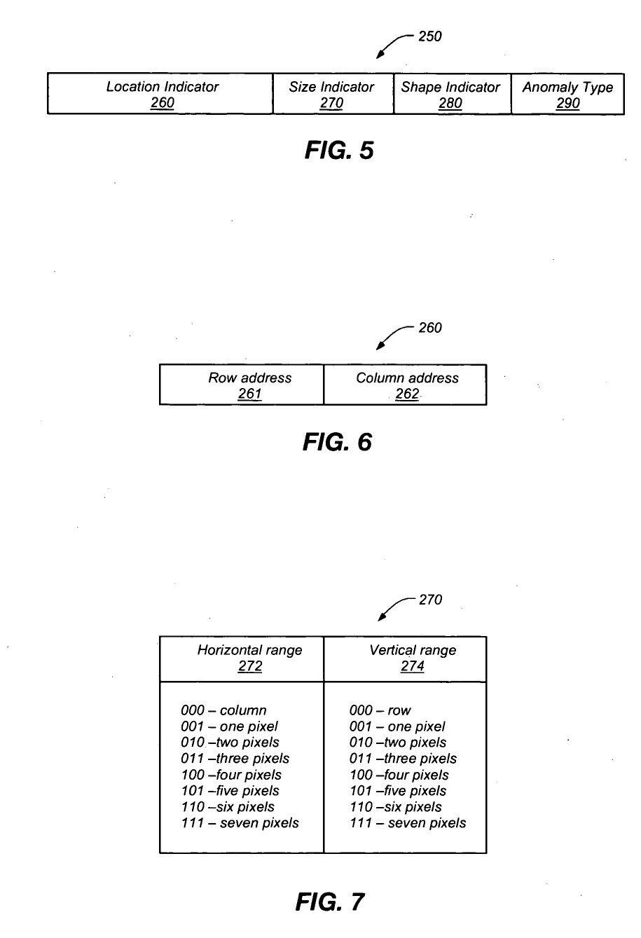

The digital signal for each pixel may be directed through a pixel processor 140. At this point, the pixel processor 140 may perform compensation operations on any anomalous pixels. The anomaly register set 200 includes a plurality of anomaly registers 250 (details shown in FIGS. 5-7, and 9-11). Each anomaly register 250 includes a plurality of nonvolatile elements. As stated earlier, the nonvolatile elements may be left un-programmed or programmed to a different state, such that the anomaly register 250 comprises a register of bits that may be read out. Programming of the nonvolatile elements is described later. As each pixel is passed through the pixel processor 140, the anomaly register set 200 may be accessed to determine if the current pixel is indicated as anomalous by one or more of the anomaly registers 250. A register decoder 210 may be used to determine the contents of the anomaly registers 250 and match them to the current pixel being processed. Access to the anomaly register set 200 may be controlled by, for example, the register decoder 210, the controller 190, or combinations thereof.

The pixel processor 140 may perform a number of functions on the pixel being processed. By way of example, and not limitation, if a pixel is identified by the anomaly register set 200 as including an anomaly, the value for the pixel may be replaced with a new value. For example, the value may be replaced by the value of a neighboring pixel or an average value from a number of neighboring pixels.

After processing, the current pixel may be transferred to the input/output (I/O) port 150 for transmission to the image processor 160. The I/O port 150 may include storage to save up values from a number of pixels such that pixel values may be transferred out of the image sensor 100 in a parallel or serial fashion.

In some embodiments, the image processor 160 may use anomaly information from the anomaly register set 200 to perform additional compensation for anomalous pixels. Thus, the image sensor 100 may include a path for the anomaly register set 200 to be read directly (not shown) or read through the register decoder 210.

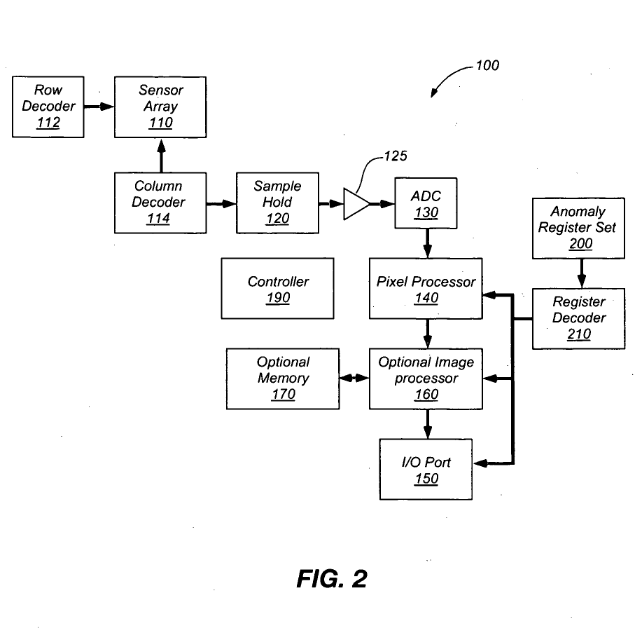

FIG. 2 is a simplified block diagram of an image sensor 100 with an optional on-chip image processor 160. The image sensor 100 of FIG. 2 includes the sensor array 110, row decoder 112, column decoder 114, controller 190, sample and hold unit 120, amplifier 125, analog to digital converter 130, pixel processor 140, I/O port 150, anomaly register set 200, and register decoders 210, with substantially the same function as described previously with respect to FIG. 1.

In addition, some representative embodiments of the present invention, as illustrated in FIG. 2, may include an optional image processor 160 for performing relatively complex image processing algorithms and more complex compensation for anomalous pixels. In this configuration, the image processor 160 may form a system on a chip function to include most or all of the elements used in an imaging system. Thus, the image processor 160 may also include memory 170 for storing digital representations of portions of an image, an entire image, multiple images, or combinations thereof. The image processor 160 may provide additional image processing functionality not included in the pixel processor 140. Whereas the pixel processor 140 may be concerned with capturing and outputting an image with some compensation for anomalous pixels, the image processor 160 may focus on increasing the quality of the image through more sophisticated algorithms and feedback to the controller 190, the memory 170, and image processor 160.

As a result, the image processor 160 may perform a variety of functions such as, for example, image filtering and compression. In addition, the image processor 160 may use anomaly information from the anomaly register set 200 to perform intelligent compensation for anomalous pixels, anomalous pixel rows, anomalous pixel columns, and anomalous pixel clusters.

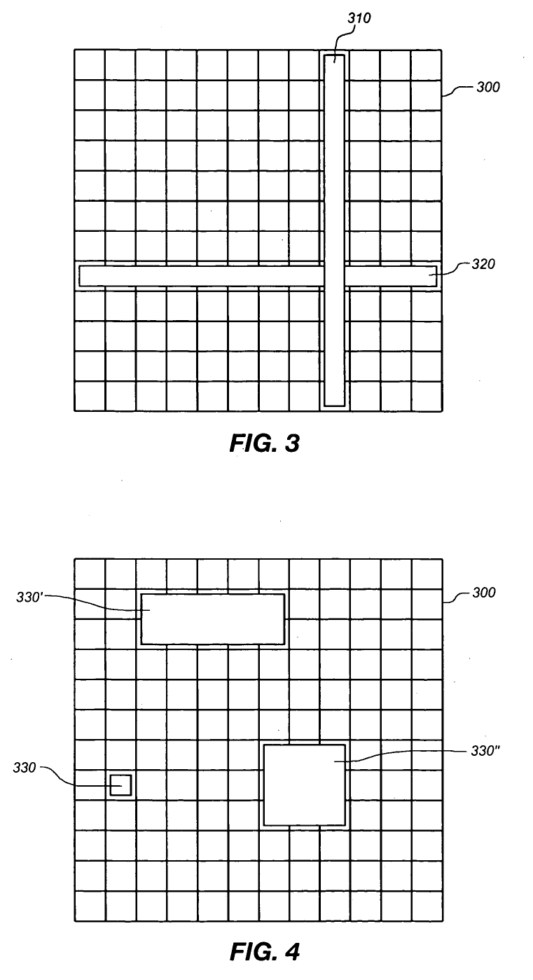

FIG. 3 illustrates a portion of a pixel array 300. Of course, a pixel array may include hundreds to thousands of rows and columns. For illustration purposes, only a small portion of the pixel array 300 is illustrated in the drawings herein. Within the pixel array 300, an entire row may include anomalies. Thus, rather than using an anomaly register to describe each pixel in the row, an anomaly register may be used to describe an entire anomalous pixel row 320. Of course, in some sensor arrays, the row may include some good pixels and some anomalous pixels. Thus, to save register space, it may be desirable to define an entire row as anomalous even if some of the pixels in that row may be good. As with the rows, an entire column, or portion of the column, may include anomalies. Thus, an anomaly register may be used to describe an entire anomalous pixel column 310.

FIG. 4 illustrates a portion of a pixel array 300 including a variety of representative anomalous pixel clusters 330. Pixel anomalies may include a cluster of neighboring pixels. Thus, rather than using an anomaly register to define each pixel in the cluster, embodiments of the present invention include a definition of a pixel cluster 330. For example, cluster 330 is a single pixel, cluster 330′ includes a rectangular shape that is two pixels high and five pixels wide, and cluster 330″ includes a rectangular shape (in this case a square) that is three pixels high and three pixels wide. As used herein, pixel cluster 330 may refer to a grouping of pixels similar to those of FIG. 4. However, pixel cluster may also be used to refer to an anomalous pixel row 320 or anomalous pixel column 320. Of course, depending on how the pixel cluster 330 is defined, it may include some good pixels and some anomalous pixels. Thus, to save register space, it may be desirable to define an pixel cluster 330 as anomalous even if some of the pixels in that cluster may be good.

FIG. 5 illustrates a representative organization for an anomaly register 250. The anomaly register 250 includes a location indicator 260 and a size indicator 270. The anomaly register 250 may also include a shape indicator 280, an anomaly type indicator 290, or combinations thereof.

FIG. 6 illustrates a representative organization for a location indicator 260 portion of the anomaly register 250 of FIG. 5. In FIG. 6, the location indicator 260 includes a row address 261 portion and a column address 262 portion. The length of the row address 261 portion and column address 262 portion may vary depending on the size of the sensor array 110. For example, a row or column address (261, 262) portion with 11 bits may be used to address up to 2048 individual rows or columns, respectively. With the row address 261 portion and the column address 262 portion, the anomaly register 250 is capable of addressing any individual pixel in the sensor array 110.

FIG. 7 illustrates a representative organization for a size indicator 270 portion of the anomaly register 250 of FIG. 5. The size indicator 270 may be segmented into a horizontal range 272 portion and a vertical range 274 portion. The number of bits in these range portions may vary depending on the maximum size of cluster to be described. By way of example, and not limitation, FIG. 7 illustrates three bit for the horizontal range 272 and three bits for the vertical range 274. Thus, the horizontal range 272 is capable of defining a range of one to seven pixels and the vertical range 274 is capable of defining a range of one to seven pixels. As a result with the number of bits shown in FIG. 7, the size indicator 270 can describe a cluster in any rectangular configuration from a single pixel up to seven pixels by seven pixels.

The location indicator 260 and the size indicator 270 may be defined in a variety of ways for pixel clusters 330. For example, the location indictor 260 may point to the upper right corner of the pixel cluster 330 while the horizontal range 272 indicates pixels to the right of the location indicator 260 and the vertical range 274 indicates pixels below the location indicator 260. As yet another example, the location indictor 260 may point to the center of the pixel cluster 330 while the horizontal range 272 indicates pixels to the right and left of the location indicator 260 and the vertical range 274 indicates pixels above and below the location indicator 260.

As a representative way of describing an anomalous pixel column 310, when the horizontal range 272 is programmed to a zero value, the entire column is defined as anomalous. Similarly, when the vertical range 274 is programmed to a zero value, the entire row is defined as anomalous. Thus, when describing an anomalous row, the vertical range 274 is set to zero, the row address 261 points to the anomalous row, and the column address 262 need not be programmed. Similarly when describing an anomalous column, the horizontal range 272 is set to zero, the column address 262 points to the anomalous column, and the row address 261 need not be programmed.

Of course, those of ordinary skill in the art will recognize that a value other than zero may be used for defining an anomalous row or column. In addition, an anomalous row may be defined in the horizontal range 272 and an anomalous column may be defined in the vertical range 274. Furthermore, combinations other than a simple binary coding may be used for defining the range values.

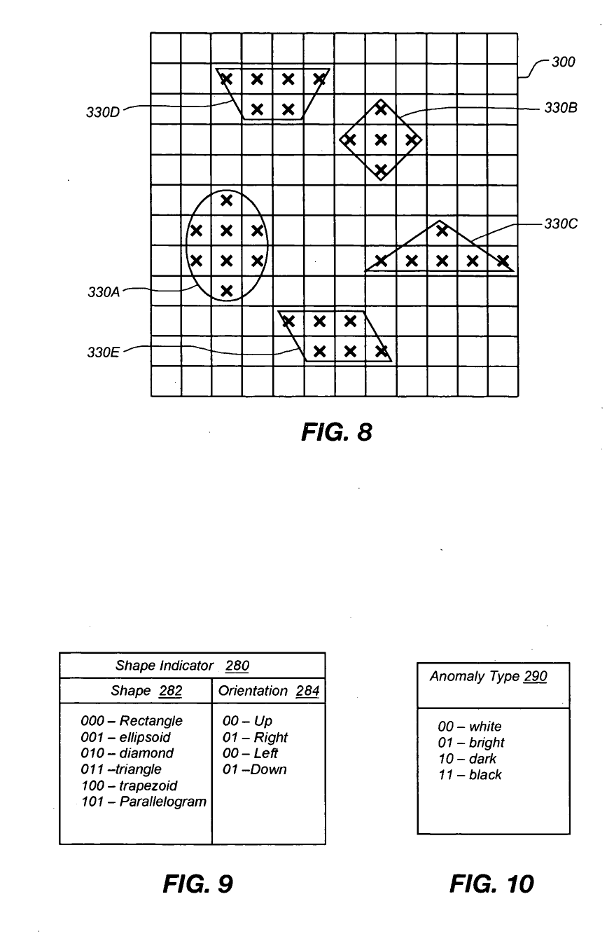

FIG. 8 illustrates a portion of a pixel array 300 including additional representative anomalous pixel clusters and some representative shapes of those pixel clusters. By way of example, some of the possible shapes that may be described are a square 330″ or rectangular shape 330′ (as illustrated in FIG. 4), an ellipsoid 330A, a diamond, 330B, a triangle, 330C, a trapezoid 330D, and a parallelogram 330E. By including a shape indicator 280, additional savings in the number of anomaly registers 250 may be possible. For example, if only rectangular shapes were possible, the ellipsoid 330A would require three anomaly registers 250. One register to describe the pixel at the top of the ellipsoid 330A, one register to describe the six pixels in the center of the ellipsoid 330A, and one register to describe the pixel at the bottom of the ellipsoid 330A. Furthermore, shape indicators 280 for anomalous pixel clusters may be useful by the pixel processor 140 or image processor 160 in creating more robust compensation algorithms for the anomalies. Of course, those of ordinary skill in the art will recognize that other shapes may be described. For example, a triangle configuration other than an isosceles triangle, such as, for example, a right triangle may be described.

FIG. 9 illustrates a representative organization for a shape indicator 280 portion of the anomaly register 250 of FIG. 5. The shapes illustrated in FIGS. 4 and 8, may be encoded in a shape portion 282 of the shape indicator 280 as illustrated in FIG. 5. Of course, those of ordinary skill in the art will recognize that any suitable encoding may be used. Some shapes, such as the triangle, trapezoid, and parallelogram, may require additional information to fully describe the shape. Therefore, if these types of shapes are used, the shape indicator 280 may include an orientation portion 284 to describe how the shape is oriented. For example, to describe the isosceles triangle, the orientation portion 284 may indicate that the apex of the triangle points up, down, to the left, or to the right. Those of ordinary skill in the art will recognize that orientations for other shapes may be defined without having to enumerate each one herein. As with the pixel clusters 330 described in FIG. 4, the shaped pixel clusters 330 illustrated in FIG. 9 may be defined with the address pointing to a specific location within the cluster and the range defining the extent of the cluster. For example, for the diamond cluster 330B, the location indicator may point to the center of the diamond, and the range indicator may define the extent of the cluster such that half the range is on one side of the center and half of the range is on the other half of the center.

FIG. 10 illustrates a representative organization for an anomaly type indicator 290 of the anomaly register 250 of FIG. 5. As discussed earlier, an anomaly type may be used to describe the way in which a pixel is defective or describe partial functionality. By way of example, and not limitation, an anomaly type indicator 290 may be encoded in two bits to include white, bright, dark, and black as described previously. Of course, more or less extensive anomaly types may be defined within the scope of the present invention.

Embodiments of the present invention may include various combinations of the shape indicator 280 and anomaly type indicator 290. For example, some embodiments may only describe rectangular clusters and as a result have no need for a shape indicator 280. Or, a shape indicator 280 may be desirable, but anomaly type indicators 290 may not be needed. Furthermore, some embodiments may not need a size indicator 270. For example, it may be desirable to include an anomaly type indicator 290, but only describe individual pixel locations with the location indicator 260. If only individual pixels are described, the size indicator is not needed.

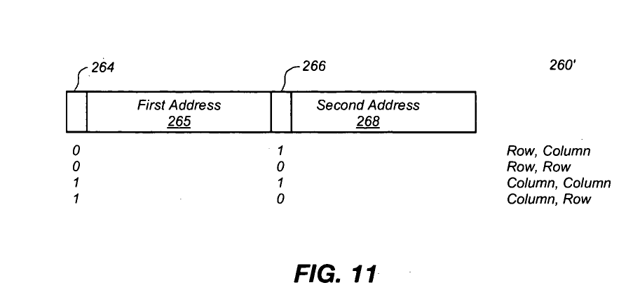

In addition, other configurations for the location indicator may be used. Recall that with the location indicator 260 of FIG. 6, if a row is designated, the column address 262 portion of the location indicator 260 is not used. Similarly, if a column is designated, the row address 261 portion of the location indicator 260 is not used. Location indicators may be defined to utilize these unused portions. For example, FIG. 11 illustrates another representative organization for a location indicator 260′ portion of the anomaly register 250 of FIG. 5. The representative embodiment of the location indicator 260′ illustrated in FIG. 11 includes a first address 265, a second address 268, a first direction flag 264, and a second direction flag 266. The first direction flag 264 may be set to a first state to indicate that the first address 265 describes a row address and a second state to indicate that the first address 265 describes a column address. Similarly, the second direction flag 266 may be set to a first state to indicate that the second address 268 describes a row address and a second state to indicate that the second address 268 describes a column address.

By way of example, FIG. 11 illustrates a “0” to designate a row and a “1” to designate a column. With this embodiment, the location indicator 260′ can indicate a specific location by a designation of “01” and a corresponding row address in the first address 265 portion and a column address in the second address 268 portion. Similarly, a specific location may be indicated by a designation of “10” and a corresponding column address in the first address 265 portion and a row address in the second address 268 portion.

In addition, the location indicator 260′ may be configured to indicate two different rows by using a “00” designation and a corresponding row address in the first address 265 portion and another row address in the second address 268 portion. Or, two different columns may be identified by using a “11” designation and a corresponding column address in the first address 265 portion and another column address in the second address 268 portion. In this way, the location indicator 260′ may be used to identify more anomalous pixels because two rows or two columns may be identified in each anomaly register 250.

With the location indicator 260′ of FIG. 11, anomalous pixel rows 320, and anomalous pixel columns 310 are encoded in the location indicator 260′. Therefore, if a size indicator 270 is included, the encodings used to indicate a row or a column, as illustrated in FIG. 7, are not needed. As a result, the horizontal range 272 and vertical range 274 may be encoded in a different fashion to include a larger possible range. For example, the values of 000-111 may represent ranges of 1-8.

In operation, and referring to FIGS. 1 and 2, the image sensor 100 may be tested, such that the anomaly register set 200 may be programmed based on the test results, or the image sensor 100 may be used in normal operation such that the values in the anomaly register set 200 may be used to compensate for anomalous pixels, anomalous pixel rows 320, anomalous pixel columns 310, and anomalous pixel clusters 330.

Testing may be performed as part of the manufacturing process prior to shipping or may be performed in situ while the image sensor 100 is in an imaging system 90. During manufacturing, the sensor array 110 may be exposed to varying intensities of light. At each intensity, the pixels may be read to determine if the intensity read is within an acceptable range. As a result of this exposure and reading, pixel quality and pixel anomalies can be determined. For example, black pixels may be detected by exposing the sensor array 110 to a full intensity light. Pixels that do not respond with a value corresponding to the full intensity may be defined as black pixels. In addition, pixels that respond, but not with a full intensity, may be defined as dark pixels. Similarly, if the senor array is exposed to darkness, pixels that do not respond with a value corresponding to the darkness may be defined as white pixels and pixels that respond, but not corresponding completely to the darkness may be defined as bright pixels. Varying degrees of light intensity may be used to define additional levels of anomalous pixel behavior. Consequently, a map of the anomalous pixels and their quality may be formed.

The resulting map may be used to group the pixels into anomalous pixel clusters 330, anomalous pixel rows 320, and anomalous pixel columns 310 as explained earlier. Then each of the anomaly registers 250 may be programmed appropriately.

In operation during use, after an image is exposed, the sensor array 110 is read out as explained earlier. As the pixels pass through the pixel processor 140, image processor 160, or combinations thereof, the register decoder 210, controller 190, or combinations thereof may read the anomalous register set 200 and decode them to determine if the current pixel in the pipeline includes an anomaly. If so, appropriate processing may be performed to compensate for the pixel anomaly.

After an image is stored, the image processor 160 may perform additional operations on the digital representation of the image to improve image quality or to perform other processing such as color correction or image compression. In this case, the image processor 160 may want information about anomalous pixels. Consequently, the anomaly registers 250 may be read directly, or via the register decoder 210, to provide anomalous pixel information to an internal or external image processor 160.

Although this invention has been described with reference to particular embodiments, the invention is not limited to these described embodiments. Rather, the invention is limited only by the appended claims, which include within their scope all equivalent devices or methods that operate according to the principles of the invention as described.

1. An image sensor device, comprising:
an array of pixels arranged on a semiconductor device wherein each pixel is configured for sensing light incident on the pixel; and
a plurality of anomaly registers comprising a plurality of nonvolatile elements, each anomaly register configured to identify an anomalous pixel cluster and comprising:
a location indicator configured for defining a row address and a column address of the anomalous pixel cluster;
a size indicator configured for defining a horizontal range and a vertical range of the anomalous pixel cluster; and
an anomaly type indicator configured to define a type of anomaly for the anomalous pixel cluster.

2. The device of claim 1, wherein the size indicator indicates an anomalous pixel row by setting the vertical range to a predetermined value.

3. The device of claim 1, wherein the size indicator indicates an anomalous pixel column by setting the horizontal range to a predetermined value.

4. The device of claim 1, wherein the type of anomaly is selected from the group consisting of white, bright, dark, and black.

5. The device of claim 1, wherein each anomaly register of the plurality further comprises a shape indicator configured for defining at least two different shapes for the anomalous pixel cluster.

6. The device of claim 5, wherein the at least two different shapes are selected from the group consisting of a rectangle, an ellipsoid, a diamond, a triangle, a trapezoid, and a parallelogram.

7. The device of claim 5, wherein the shape indicator includes an orientation indicator.

8. An image sensor device, comprising:
an array of pixels arranged on a semiconductor device wherein each pixel is configured for sensing light incident on the pixel; and
a plurality of anomaly registers comprising a plurality of nonvolatile elements, each anomaly register configured to identify an anomalous pixel cluster and comprising:
a location indicator configured for defining a row address and a column address of the anomalous pixel cluster;
a size indicator configured for defining a horizontal range and a vertical range of the anomalous pixel cluster; and
a shape indicator configured for defining at least two different shapes for the anomalous pixel cluster.

9. The device of claim 8, wherein the size indicator indicates an anomalous pixel row by setting the vertical range to a predetermined value.

10. The device of claim 8, wherein the size indicator indicates an anomalous pixel column by setting the horizontal range to a predetermined value.

11. The device of claim 8, wherein the at least two different shapes are selected from the group consisting of a rectangle, an ellipsoid, a diamond, a triangle, a trapezoid, and a parallelogram.

12. The device of claim 8, wherein the shape indicator includes an orientation indicator.

13. The device of claim 8, wherein each anomaly register of the plurality further comprises an anomaly type indicator configured to define a type of anomaly for the anomalous pixel cluster.

14. The device of claim 13, wherein the type of anomaly is selected from the group consisting of white, bright, dark, and black.

15. An image sensor device, comprising:
an array of pixels arranged on a semiconductor device wherein each pixel is configured for sensing light incident on the pixel; and
a plurality of anomaly registers comprising a plurality of nonvolatile elements, each anomaly register including:
a first address;
a second address;
a first direction flag associated with the first address; and
a second direction flag associated with the second address;
wherein the first direction flag and the second direction flag are each configured to be in a first state to indicate a row address or a second state to indicate a column address;
and wherein:
when the first direction flag and the second direction flag are in opposite states, a combination of the first address and the second address indicates a location of an anomalous pixel cluster determined by the row address and the column address;
when the first direction flag and the second direction flag are both in the first state, the first address indicates a location of a first anomalous pixel row and the second address indicates a location of a second anomalous pixel row; and
when the first direction flag and the second direction flag are both in the second state, the first address indicates a location of a first anomalous pixel column and the second address indicates a location of a second anomalous pixel column.

16. The device of claim 15, wherein each anomaly register of the plurality further comprises a size indicator configured for defining a horizontal range and a vertical range of the anomalous pixel cluster.

17. The device of claim 15, wherein each anomaly register of the plurality further comprises a shape indicator configured for defining at least two different shapes for the anomalous pixel cluster.

18. The device of claim 15, wherein each anomaly register of the plurality further comprises an anomaly type indicator configured to define a type of anomaly for the anomalous pixel cluster or the first and second anomalous pixel row, or the first and second anomalous pixel column.

19. The device of claim 18, wherein the type of anomaly is selected from the group consisting of white, bright, dark, and black.

20. A method of operating an image sensor, comprising:
obtaining anomaly information on each pixel of an array of pixels during fabrication and testing of a semiconductor device bearing the array of pixels; and
storing at least a portion of the anomaly information in an anomaly register comprising a plurality of nonvolatile elements on the semiconductor device, wherein the portion of the anomaly information identifies an anomalous pixel cluster by indicating a location, a horizontal range, a vertical range, and an anomaly type of the anomalous pixel cluster.

21. The method of claim 20, wherein the location and a predetermined value for the vertical range combine to indicate an anomalous pixel row.

22. The method of claim 20, wherein the location and a predetermined value for the horizontal range combine to indicate an anomalous pixel column.

23. The device of claim 20, wherein the anomaly type is selected from the group consisting of white, bright, dark, and black.

24. The method of claim 20, further comprising storing a shape of the anomalous pixel cluster in the anomaly register.

25. The device of claim 24, wherein the shape of the anomalous pixel cluster is selected from the group consisting of a rectangle, an ellipsoid, a diamond, a triangle, a trapezoid, and a parallelogram.

26. A method of manufacturing an image sensor, comprising:
obtaining anomaly information on each pixel of an array of pixels during fabrication and testing of a semiconductor device bearing the array of pixels; and
storing at least a portion of the anomaly information in an anomaly register comprising a plurality of nonvolatile elements on the semiconductor device, wherein the portion of the anomaly information identifies an anomalous pixel cluster by indicating a location, a horizontal range, a vertical range, and a shape of the anomalous pixel cluster.

27. The method of claim 26, wherein the location and a predetermined value for the vertical range combine to indicate an anomalous pixel row.

28. The method of claim 26, wherein the location and a predetermined value for the horizontal range combine to indicate an anomalous pixel column.

29. The device of claim 26, wherein the shape of the anomalous pixel cluster is selected from the group consisting of a rectangle, an ellipsoid, a diamond, a triangle, a trapezoid, and a parallelogram.

30. The method of claim 26, further comprising storing an anomaly type of the anomalous pixel cluster in the anomaly register.

31. The device of claim 30, wherein the anomaly type is selected from the group consisting of white, bright, dark, and black.

32. A method of operating an image sensor, comprising:
obtaining a digital representation of an image captured with an image sensor;
reading at least one anomaly register of a plurality of anomaly registers on the image sensor to retrieve anomaly information for an anomalous pixel cluster, wherein each anomaly register of the plurality includes a location, a horizontal range, a vertical range, and an anomaly type of the anomalous pixel cluster; and
redefining pixel values in the anomalous pixel cluster with pixel data associated with at least one pixel substantially near the anomalous pixel cluster.

33. The method of claim 32, wherein the location and a predetermined value for the vertical range combine to indicate an anomalous pixel row.

34. The method of claim 32, wherein the location and a predetermined value for the horizontal range combine to indicate an anomalous pixel column.

35. The device of claim 32, wherein the anomaly type is selected from the group consisting of white, bright, dark, and black.

36. The method of claim 32, further comprising storing a shape of the anomalous pixel cluster in the anomaly register.

37. The device of claim 36, wherein the shape of the anomalous pixel cluster is selected from the group consisting of a rectangle, an ellipsoid, a diamond, a triangle, a trapezoid, and a parallelogram.

38. An imaging system, comprising:
an image sensor, comprising:
an array of pixels arranged on a semiconductor device wherein each pixel is configured for sensing light incident on the pixel; and
a plurality of anomaly registers comprising a plurality of nonvolatile elements, each anomaly register configured to identify an anomalous pixel cluster and comprising:
a location indicator configured for defining a row address and a column address of the anomalous pixel cluster;
a size indicator configured for defining a horizontal range and a vertical range of the anomalous pixel cluster; and
an anomaly type indicator configured to define a type of anomaly for the anomalous pixel cluster;
an image processor configured for reading a digital representation of the image from the image sensor;
a memory configured for storing the digital representation of the image; and
a communication element configured for communicating the digital representation of the image to an external device.
